(19) United States
(12) Patent Application Publication
(10) Pub. No.: US 2022/0123285 A1
(43) Pub. Date: Apr. 21, 2022

(54) COMPOSITE STRUCTURE, LITHIUM BATTERY, AND METHOD OF PRODUCING COMPOSITE STRUCTURE

(71) Applicant: TOYOTA JIDOSHA KABUSHIKI KAISHA, Toyota-shi Aichi-ken (JP)

(72) Inventors: Shingo Ohta, Nagakute-shi (JP); Masaki Watanabe, Shizuoka-ken (JP); Yasutoshi Hojo, Numazu-shi (JP)

(21) Appl. No.: 17/561,205

(22) Filed: Dec. 23, 2021

Related U.S. Application Data
(62) Division of application No. 16/676,990, filed on Nov. 7, 2019.

(30) Foreign Application Priority Data
Nov. 9, 2018 (JP) 2018-211307

(51) Int. Cl. H01M 4/36; H01M 4/04; H01M 4/80; H01M 4/1391; H01M 10/0562

(52) U.S. Cl. CPC H01M 4/366; H01M 4/0471; H01M 2300/0071; H01M 4/1391; H01M 10/0562; H01M 4/80

(57) ABSTRACT

A composite structure is adapted to a separator of a secondary battery, and includes a compact layer containing a solid electrolyte and a porous layer which contains a solid electrolyte and is integrally formed with the compact layer without having a bonding interface.

### CROSS-REFERENCE TO RELATED APPLICATIONS

This application is a divisional application of U.S. patent application Ser. No. 16/676,990 filed Nov. 7, 2019, which claims priority to Japanese Patent Application No. 2018-211307 filed on Nov. 9, 2018, which is incorporated herein by reference in its entirety including the specification, drawings and abstract.

### BACKGROUND

### 1. Technical Field

The present disclosure relates to a composite structure, a lithium battery, and a method of producing a composite structure.

### 2. Description of Related Art

In the related art, regarding a solid electrolyte, a garnet ion conductive oxide containing Li, La and Zr has been proposed as a solid electrolyte (for example, refer to Journal of Power Sources, 363: 145-152, September 2017 with-92 Reads). In Journal of Power Sources, 363: 145-152, September 2017 with-92 Reads, in a garnet solid electrolyte, growth of lithium during charging causes a problem and there is a risk of short circuiting. However, a higher critical current density is exhibited by modifying grain boundaries of pellets with Li₂CO₃ and LiOH.

### SUMMARY

However, in Journal of Power Sources, 363: 145-152, September 2017 with-92 Reads, a higher critical current density is exhibited according to a fine structure of the crystal grain boundary. However, lithium is grown via voids, it is not possible to prevent short circuiting, and further improvement has been desired.

The present disclosure provides a composite structure, a lithium battery, and a method of producing a composite structure through which it is possible to prevent short circuiting in a solid electrolyte separator used in a secondary battery.

The inventors conducted extensive studies and found that, when a precipitation field in which a metal is precipitated is secured in a porous layer and a compact layer for preventing short circuiting is integrally formed, it is possible to achieve both ion conductivity and prevention of short circuiting, and completed the disclosure disclosed in this specification.

A composite structure of the present disclosure is a composite structure adapted to a separator of a secondary battery, and includes a compact layer containing a solid electrolyte and a porous layer which contains the solid electrolyte and is integrally formed with the compact layer without having a bonding interface.

A lithium battery of the present disclosure includes a positive electrode containing a positive electrode active material, a negative electrode containing a negative electrode active material, and the above composite structure interposed between the positive electrode and the negative electrode.

A method of producing a composite structure of the present disclosure is a method of producing a composite structure adapted to a separator of a secondary battery, and includes a laminating process in which a first layer in which a hydrogen-containing solid electrolyte powder is filled and a second layer in which a powder obtained by mixing hydrogen-containing solid electrolyte particles and an alkali hydroxide is filled are formed to obtain a laminate; and a firing process in which the laminate is fired at a temperature at which the hydrogen-containing solid electrolyte and the alkali hydroxide are chemically sintered.

In the composite structure, the lithium battery, and the method of producing a composite structure of the present disclosure, it is possible to prevent internal short circuiting of the secondary battery. The reason why such an effect is obtained is speculated as follows. For example, it is speculated that a precipitation field in which a metal precipitates is secured in the porous layer, and a compact layer for preventing short circuiting is integrally formed, and thus both ion conductivity and short circuiting prevention can be achieved.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an explanatory diagram showing an example of a structure of a lithium battery 10;

FIG. 2A is an explanatory diagram of a method of producing a composite structure;

FIG. 2B is an explanatory diagram of a method of producing a composite structure;

FIG. 2C is an explanatory diagram of a method of producing a composite structure;

FIG. 2D is an explanatory diagram of a method of producing a composite structure;

FIG. 3 is an explanatory diagram of a symmetric cell 40 used for a Fi dissolution precipitation test;

FIG. 4 shows results of a dissolution precipitation test for a symmetric cell;

FIG. 5A shows a metal precipitation model diagram;

FIG. 5B shows a metal precipitation model diagram;

FIG. 5C shows a metal precipitation model diagram;

FIG. 5D shows a metal precipitation model diagram;

FIG. 5E shows an SEM image of a separator;

FIG. 6 shows diagrams of the relationship between a composition and a porosity of a sintering aid;

FIG. 7A shows a diagram of the relationship between a composition and a porosity of a sintering aid, and electrical conductivity;

FIG. 7B shows a diagram of the relationship between a composition and a porosity of a sintering aid, and electrical conductivity;

FIG. 8 shows a raw material volume fraction and an SEM image of a composite structure of porous layer/compact layer/porous layer;

FIG. 9 shows SEM images of the composite structure of porous layer/compact layer/porous layer;

FIG. 10 shows results of a dissolution precipitation test for the composite structure of porous layer/compact layer/porous layer;

FIG. 11A shows an impedance measurement result of the composite structure subjected to a Li dissolution precipitation test; and

FIG. 11B shows an impedance measurement result of the composite structure subjected to a Li dissolution precipitation test.

### DETAILED DESCRIPTION OF EMBODIMENTS

### (Composite Structure)

A composite structure of the present disclosure is a composite structure adapted to a separator of a secondary battery including a compact layer containing a solid electrolyte and a porous layer which contains a solid electrolyte and is integrally formed with the compact layer without having a bonding interface. The composite structure may conduct alkali metal ions. Examples of alkali metals include lithium, sodium, and potassium. In some embodiment, the alkali metal is lithium. Hereinafter, those that conduct lithium ions will be mainly described.

The composite structure may contain a solid electrolyte. The solid electrolyte of the compact layer and the solid electrolyte of the porous layer in the composite structure may be the same material, and may be materials with partially different compositions. The solid electrolyte is not particularly limited, and in some embodiments the solid electrolyte is an oxide-based inorganic solid electrolyte, and examples thereof include a garnet oxide having lithium ion conductivity. The garnet oxide has lithium reduction resistance and a wide potential window. The garnet oxide may contain at least Li, La, and Zr. Alternatively, the garnet oxide may contain at least Li, La, and Y. In addition, the garnet oxide may additionally contain at least one element A of an alkaline earth metal and a lanthanoid element which are elements different from La and at least one element T which is an element different from Zr and Y and selected from among transition elements that can 6-coordinate with oxygen and typical elements belonging to Group 12 to Group 15. In addition, a Li site of the garnet oxide may be replaced with a 3-valent element such as Al or Ga. More specifically, the solid electrolyte may have a garnet oxide represented by a basic composition (Li_{7-3x+y-z}Mₓ)(La_{3-y}A_{y})(Zr_{2-z}T_{z})O1₂ or, (Li_{7-3x+y-z}Mₓ)(La_{3-y}A_{y})(Y_{2-z}T_{z})O₁₂. Here, in the formula, M is one or more of Al and Ga, A is one or more of Ca and Sr, T is one or more of Nb and Ta, and 0≤x≤0.2, 0≤y≤0.2, and 0≤z≤2 are satisfied. If a garnet oxide contains Sr, the melting point can be lowered, the firing temperature can be lowered, and the firing energy can be further reduced. In addition, if Ca is contained, lithium ion conductivity can be further improved. In some embodiments, T is Nb. When Nb is contained in a garnet oxide, lithium ion conductivity can be further increased. In some embodiments, the basic composition formula satisfies 0.05≤x≤0.1. In some embodiments, the basic composition formula satisfies 0.05≤y≤0.1. In some embodiments, the basic composition formula satisfies 0.1≤z≤0.8.

Here, the garnet oxide need only mainly have a garnet structure, may include, for example, a part of a structure other than the garnet type, and may include a distorted structure as viewed from the garnet structure such as a shifted X-ray diffraction peak position. In addition, as shown in the composition formula, in the composite structure, other elements and structures may be partially contained. In addition, “basic composition” indicates that elements M, A, and T may include a main component element and one or more sub-component elements. Here, details of a garnet lithium ion conductive oxide are described in, for example, Japanese Patent Application Publication No. 2010-202499.

In addition, examples of inorganic solid electrolytes include Li₃N, and Li₁₄Zn(GeO₄)₄ called LISICON, sulfide Li_{3.25}Ge_{0.25}P_{0.75}S₄, perovskite type La_{0.5}Li_{0.5}TiO₃, (La_{2/3}Li_{3x□1/3-2x})TiO₃ (□: atomic vacancy), garnet type Li₇La₃Zr₂O₁₂, and LiTi₂(PO₄)₃ and Li_{1.3}M_{0.3}Ti_{1.7}(PO₃)₄ (M=Sc, Al) called a NASICON type. In addition, examples thereof include Li₇P₃S₁₁ obtained from a glass having a composition of 80Li₂S-20P₂S₅ (mol %) which is a glass ceramic, and Li₁₀Ge₂PS₂ which is a sulfide material having high conductivity. Examples of glass inorganic solid electrolytes include Li₂S—SiS₂, Li₂S—SiS₂—LiI, Li₂S—SiS₂—Li₃PO₄, Li₂S—SiS₂—Li₄SiO₄, Li₂S—P₂S₅, Li₃PO₄—Li₄SiO₄, Li₃BO₄—Li₄SiO₄, and those in which SiO₂, GeO₂, B₂O₃, or P₂O₅ is used as a glass material, and Li₂O is used as a network modifying material. In addition, examples of thio-LISICON solid electrolytes include Li₂S—GeS₂, Li₂S—GeS₂—ZnS, Li₂S—Ga₂S₂, Li₂S—GeS₂—Ga₂S₃, Li₂S—GeS₂—P₂S₅, Li₂S—GeS₂—SbS₅, Li₂S—GeS₂—Al₂S₃, Li₂S—SiS₂, Li₂S—P₂S₅, Li₂S—Al₂S₃, LiS—SiS₂—Al₂S₃, and Li₂S—SiS₂—P₂S₅ solid electrolytes.

The compact layer is a part in which a solid electrolyte is dense, and for example, a layer having a relative density of 90% or more may be used. In some embodiments, relative density of the compact layer is higher than 90%, such as 92% or more, 95% or more, or 98% or more. The relative density is calculated as a relative density if the density when the solid electrolyte has no voids is set as 100%. The relative density is calculated without considering a sintering aid. The relative density calculated without considering a sintering aid is lower than the relative density calculated while considering a sintering aid, and thus overestimation can be prevented. The thickness of the compact layer may be in a range of 2 μm or more and 300 μm or less. When the thickness is 2 μm or more, short circuiting of the electrode is more easily prevented, and when the thickness is 300 μm or less, ion conductivity is more easily secured. In some embodiments, the thickness of the compact layer is 5 μm or more, 10 μm or more, or 20 μm or more. In some other embodiments, the thickness of the compact layer is 200 μm or less, 150 μm or less, or 100 μm or less. In order to produce the compact layer, in situations in which there are about 10 solid electrolyte particles, when the particle size of the solid electrolyte is 0.5 μm, the compact layer with a thickness of 5 μm can be produced, and, in some embodiments, a thickness of the compact layer is within a range of 15 μm or more and 100 μm or less.

The porous layer is a part having more voids in the solid electrolyte integrally formed with the compact layer. The porous layer does not have a bonding interface between it and the compact layer. The porous layer is a layer bonded to an electrode of a secondary battery. The porous layer may be formed on a first surface of the compact layer or may be formed on a first surface and a second surface behind the first surface, and in some embodiments, may be formed on a first surface and a second surface. In some embodiments, the composite structure has a structure of porous layer/compact layer/porous layer in consideration of ease of production. In addition, in the composite structure including a 3-layer structure of porous layer/compact layer/porous layer, when the center of the compact layer is cut, a 2-layer structure of porous layer/compact layer can also be obtained. Alternatively, within the 3-layer structure, one porous layer can be cut to obtain a 2-layer structure of porous layer/compact layer. For example, the porous layer may have a relative density in the range of 40% or more and 60% or less. When the relative density is 40% or more, metal carriers precipitated from the electrode due to charging and discharging can be sufficiently received in the voids. In addition, when the relative density is 60% or less, the presence of the solid electrolyte can be secured and decrease in the ion conductivity can be further reduced. This relative density is calculated in the same manner as in the compact layer. In addition, the porous layer may have a thickness in the range of 2 μm or more and 100 μm or less. When the thickness is 2 μm or more, metal carriers precipitated from the electrode due to charging and discharging can be sufficiently received in the voids. In addition, when the thickness is 100 μm or less, ion conduction resistance can be further reduced. In some embodiments, for example, the thickness of the porous layer is 5 μm or more, 10 μm or more, or 15 μm or more. In some other embodiments, for example, the thickness of the porous layer is 80 μm or less, 60 μm or less, or 50 μm or less.

The porous layer may have voids formed by evaporation of a sintering aid according to a chemical reaction with a component contained in the solid electrolyte. Specifically, the porous layer may have voids formed when a hydrogen-containing solid electrolyte reacts with an alkali hydroxide sintering aid and water is evaporated. In the composite structure, pores can be formed while improving ion conductivity.

At least one of the compact layer and the porous layer may contain a sintering aid. The sintering aid may be present at the grain boundary part of solid electrolyte particles. The compact layer and/or the porous layer may contain 20 volume % or less of a sintering aid with respect to the volume of the solid electrolyte. In some embodiments, for example, the sintering aid has lithium ion conductivity and may contain at least Li and B. In some embodiments, the sintering aid is lithium borate. Examples of lithium borate include Li₃BO₃, Li₂B₄O₇, and LiBO₂. In some embodiments, the lithium borate is Li₃BO₃ (hereinafter referred to as LBO) because it is less reactive with the solid electrolyte. In addition, regarding the sintering aid, aluminum oxide, gallium oxide, or the like may be used. An Al or Ga sintering aid may be contained in the Li site of a garnet oxide containing Li. In addition, 5 volume % or less of an Al or Ga sintering aid may be contained with respect to the volume of the solid electrolyte. Alternatively, examples of sintering aids include those that chemically react with a component contained in the solid electrolyte due to firing and evaporate. Examples of such sintering aids include an alkali hydroxide. Examples of alkali hydroxides include Li, Na, and K hydroxides and the like. In some embodiments, the alkali hydroxides is lithium hydroxide. In some embodiments, since an alkali hydroxide has low ion conductivity, the content in the compact layer and the porous layer may be smaller. In some embodiments, the content of the alkali hydroxide is in a range of 36 volume % or less with respect to the solid electrolyte. In this range, decrease in the contact ability between solid electrolyte particles can be further reduced and decrease in the ion conductivity can be further reduced.

In the composite structure, for example, the solid electrolyte may be chemically sintered to form a compact layer and a porous layer. Examples of chemical sintering include a dehydration reaction between a hydrogen-containing solid electrolyte and an alkali hydroxide. In some embodiments, in the composite structure, the electrical conductivity (lithium ion conductivity, 25° C.) is 0.4×10⁻⁴ (S/cm) or more, 1.0×10⁻⁴ (S/cm) or more, or 1.5×10⁻⁴ (S/cm) or more. The electrical conductivity can be appropriately changed by adjusting the sintering aid, the addition ratio (x, y, z) of elements M, A, and T of the basic composition formula, and the firing temperature.

In some embodiments, the composite structure is fired in a temperature range in which the solid electrolyte is chemically sintered. In some embodiments, regarding the firing temperature, for example, firing is performed at 1,100° C. or lower, firing is performed at 1,050° C. or lower, or firing is performed at 1,000° C. or lower. In firing at 1,100° C. or lower, firing energy can be further reduced. In some embodiments, in order to sinter the solid electrolyte, the composite structure is fired at 700° C. or higher, 750° C. or higher, or 800° C. or higher.

The composite structure can be used for a lithium battery because it has higher lithium ion conductivity. In this case, for example, the composite structure may be used as a solid electrolyte of a lithium battery or may be used as a separator of a lithium battery.

### (Lithium Battery)

A lithium battery of the present disclosure has the above composite structure. The lithium battery may be a secondary battery or an all-solid state lithium battery. For example, the lithium battery may include a positive electrode containing a positive electrode active material, a negative electrode containing a negative electrode active material, and the above composite structure interposed between the positive electrode and the negative electrode. In addition, in the lithium battery, in the composite structure, the compact layer may be arranged on the side of the positive electrode, and the porous layer may be arranged on the side of the negative electrode. The composite structure may have a 2-layer structure of a compact layer and a porous layer. In such a battery structure, the porous layer which is a lithium metal precipitation field is on the side of the negative electrode in which a lithium metal is likely to precipitate, and the compact layer in which short circuiting can be reduced is arranged on the side of the positive electrode and thus a stronger short circuiting prevention effect can be obtained. In some embodiments, in consideration of an energy density, the composite structure having a 2-layer structure is selected over a 3-layer structure of porous layer/compact layer/porous layer.

The positive electrode may be formed, for example, by applying a paste-like positive electrode material obtained by mixing a positive electrode active material, a conductive material, and a binder, adding a suitable solvent to a surface of a current collector, and performing drying and compressing as necessary to increase an electrode density. Regarding the positive electrode active material, a sulfide containing a transition metal element, an oxide containing lithium and a transition metal element, or the like can be used. Specifically, a transition metal sulfide such as TiS₂, TiS₃, MoS₃, or FeS₂, a lithium manganese composite oxide having a basic composition formula of Li(1−x)MnO₂ (for example, 0<x<1, the same applies hereinafter), Li₍₁₋ₓ₎Mn₂O₄ or the like, a lithium cobalt composite oxide having a basic composition formula of Li₍₁₋ₓ₎CoO₂ or the like, a lithium nickel composite oxide having a basic composition formula of Li₍₁₋ₓ₎NiO₂ or the like, a lithium nickel cobalt manganese composite oxide having a basic composition formula of Li₍₁₋ₓ₎NiₐCo_{b}Mn_{c}O₂ (a+b+c=1) or the like, a lithium vanadium composite oxide having a basic composition formula of LiV₂O₃ or the like, a transition metal oxide having a basic composition formula of V₂O₅ or the like, and the like can be used. In some embodiments, a lithium transition metal composite oxide, for example, LiCoO₂, LiNiO₂, LiMnO₂, or LiV₂O₃, is selected. Here, the “basic composition formula” may include other elements. The conductive material is not particularly limited as long as it is an electron conductive material that does not negatively influence battery performance of the positive electrode. For example, graphite such as natural graphite (scaly graphite, flaky graphite) and artificial graphite, acetylene black, carbon black, Ketjen black, carbon whisker, needle coke, carbon fibers, and a metal (copper, nickel, aluminum, silver, gold, etc.) may be used alone or two or more thereof may be used in combination. In some embodiments, regarding the conductive material, in consideration of electron conductivity and coating properties, carbon black and acetylene black are selected. The binder has a function of binding active material particles and conductive material particles, and for example, a fluorine-containing resin such as polytetrafluoroethylene (PTFE), polyvinylidene fluoride (PVDF), and a fluoro rubber, a thermoplastic resin such as a polypropylene and a polyethylene, an ethylene propylene diene monomer (EPDM) rubber, a sulfonated EPDM rubber, and a natural butyl rubber (NBR) may be used alone or two or more thereof may be used in combination. In addition, a water dispersion of cellulose and styrene butadiene rubber (SBR) which is an aqueous binder or the like can be used. Regarding a solvent in which a positive electrode active material, a conductive material, and a binder are dispersed, for example, an organic solvent such as N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran can be used. In addition, a dispersant, a thickener, and the like are added to water, and an active material may be slurried in latex such as SBR. Regarding the thickener, for example, polysaccharides such as carboxymethylcellulose and methylcellulose may be used alone or two or more thereof may be used in combination. Examples of an application method include roller coating using, for example, an applicator roller, screen coating, a doctor blade method, spin coating, and a bar coater method, and any of these can be used to form an arbitrary thickness and shape. Regarding the current collector, those of which a surface of aluminum, copper or the like is treated with carbon, nickel, titanium, or silver in order to improve adhesiveness, conductivity, and oxidation resistance can be used in addition to aluminum, titanium, stainless steel, nickel, iron, fired carbon, a conductive polymer, and conductive glass. The surface of the current collector can be oxidized. Examples of the shape of the current collector include a foil form, a film form, a sheet form, a net form, a punched or expanded form, a lath form, a porous form, a foam, and a fiber group form. The current collector having a thickness of, for example, 1 μm to 500 μm, is used.

The negative electrode may be formed by adhering a negative electrode active material and a current collector. For example, a paste-like negative electrode material obtained by mixing a negative electrode active material, a conductive material, and a binder and adding a suitable solvent is applied to a surface of a current collector and then is dried, and compressing are performed as necessary to increase an electrode density for formation. Examples of negative electrode active materials include lithium, a lithium alloy, an inorganic compound such as a tin compound, a carbonaceous material that can occlude and release lithium ions, a composite oxide containing a plurality of elements, and a conductive polymer. Examples of carbonaceous materials include cokes, glassy carbons, graphites, non-graphitizable carbons, pyrolytic carbons, and carbon fibers. In some embodiments, the carbonaceous materials includes graphites such as artificial graphite and natural graphite because they have an operation potential close to that of the metal lithium, and enable charging and discharging at a high operation voltage, can reduce self-discharging when a lithium salt is used as a support salt, and can reduce an irreversible capacity during charging. Examples of a composite oxide include a lithium titanium composite oxide and a lithium vanadium composite oxide. In some embodiments, a carbonaceous material is the negative electrode active material in consideration of safety. In addition, as a conductive material, a binder, a solvent and the like used in the negative electrode, those exemplified in the positive electrode can be used. Regarding the current collector of the negative electrode, in addition to copper, nickel, stainless steel, titanium, aluminum, fired carbon, a conductive polymer, conductive glass, an Al—Cd alloy, and the like, in order to improve adhesiveness, conductivity, and reduction resistance, those of which a surface of copper or the like is treated with, for example, carbon, nickel, titanium or silver can be used. The surface of the current collector can be oxidized. The shape of the current collector can be the same as that of the positive electrode.

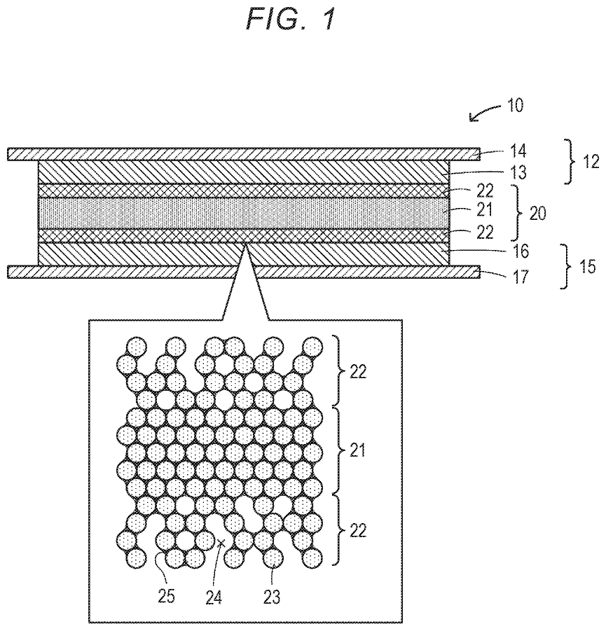

The structure of the lithium battery is not particularly limited, and for example, a structure shown in FIG. 1 may be used. FIG. 1 is explanatory diagram showing an example of a structure of a lithium battery 10. The lithium battery 10 includes a positive electrode 12, a negative electrode 15, and a separator 20. The positive electrode 12 includes a positive electrode active material layer 13 and a current collector 14. The negative electrode 15 includes a negative electrode active material layer 16 and a current collector 17. The separator 20 has the above composite structure, which is a multi-layer structure of porous layer 22/compact layer 21/porous layer 22. The positive electrode active material layer 13 is formed on the surface of one porous layer 22, and the negative electrode active material layer 16 is formed on the surface of the other porous layer 22. This separator contains solid electrolyte particles 23, and grain boundary parts are formed at the grain boundaries. The grain boundary parts 25 may include, for example, a sintering aid. In the porous layer 22, voids 24 are formed. The voids 24 may be formed by evaporation of a sintering aid according to a chemical reaction with a component contained in the solid electrolyte. Specifically, the voids 24 may be formed when a hydrogen-containing solid electrolyte reacts with an alkali hydroxide sintering aid and water is evaporated.

### (Method of Producing a Composite Structure)

Next, a method of producing a composite structure of the present disclosure will be described. This production method is a method of producing a composite structure used for a separator of a secondary battery. The production method includes a laminating process of forming a laminate and a firing process of firing the laminate. In the production method, a composite structure used as a separator is produced by chemical sintering with a chemical reaction between hydrogen and hydroxide without melting and sintering which have a limit for forming pores. In particular, a compact layer can be formed by chemical sintering and a porous layer can be formed in the same process by evaporation of water.

In the laminating process, a first layer in which a hydrogen-containing solid electrolyte powder is filled and a second layer in which a powder obtained by mixing hydrogen-containing solid electrolyte particles and an alkali hydroxide is filled are formed to obtain a laminate. The first layer serves as a compact layer, and the second layer serves as a porous layer. The second layer may be formed on at least one of a first surface and a second surface of the first layer, and, in some embodiments, the second layer formed on the first surface and the second surface. That is, in the process, a laminate of second layer/first layer/second layer may be produced. In some embodiments, the same layer is provided on both sides because warpage during firing can be further reduced. Here, after the laminating process, a process of performing division at the center of the first layer in the 3-layer structure may be performed, and after the firing process, a process of performing division at the center of the compact layer in the 3-layer structure may be performed. Alternatively, after the firing process, a process of cutting one porous layer in the 3-layer structure may be performed. When this division process or cutting process is performed, a 2-layer structure of porous layer/compact layer can be obtained. In the laminating process, the first layer may be formed using a hydrogen-containing solid electrolyte which is a garnet oxide containing at least Li, H, La and Zr, and the second layer may be formed using a hydrogen-containing solid electrolyte which is a garnet oxide containing at least Li, H, La and Zr and an alkali hydroxide which is a lithium hydroxide. Alternatively, in this process, a garnet oxide containing at least Li, H, La, and Y may be used. Regarding the hydrogen-containing solid electrolyte, for example, those represented by a basic composition (Li_{7-3x+y-z-a}HₐMₓ)(La_{3-y}A_{y})(Zr_{2-z}T_{z})O₁₂ or (Li_{7-3x+y-z-a}HₐMₓ)(La_{3-y}A_{y})(Y_{2-z}T_{z})O₁₂ may be used. However, in the formula, M is one or more of Al and Ga, A is one or more of Ca and Sr, T is one or more of Nb and Ta, and 0≤x≤0.2, 0≤y≤0.2, 0≤z≤2, and 0.9≤a≤2.2 are satisfied. In the basic composition formula, when the hydrogen content a is 0.9 or more, sintering can be further promoted and decrease in the electrical conductivity (ion conductivity) can be further reduced. In addition, when the hydrogen content a is 2.2 or less, decrease in the crystallinity of the solid electrolyte is further reduced, and thus decrease in the electrical conductivity can be further reduced. In addition, the hydrogen-containing solid electrolyte can be produced as follows. For example, a garnet oxide containing no hydrogen is produced, and an excess amount of an alkali hydroxide (for example, lithium hydroxide) is then added thereto, mixed, and pulverized. This mixed and pulverized product is preliminarily fired in a temperature range of 700° C. to 900° C., and immersed in water when there are no remaining unreacted raw material components, and thus exchange between an alkali metal and hydrogen is performed. The exchange between the alkali and hydrogen is not limited to being left but it may be performed, for example, by applying an ultrasound with an ultrasonic cleaning machine. In addition, an amount of water with respect to the garnet oxide may be increased. An immersion time may be 30 minutes or longer, and may be shortened or lengthened. In addition, an exchange operation between the alkali metal and hydrogen may be repeated a plurality of times. An amount of H exchanged can be controlled by changing conditions, and an amount of H can be controlled in a range of 0≤a≤2.8. A method of forming a first layer and a second layer is not particularly limited, and for example, raw material particles may be filled into a mold and pressed and molded. Alternatively, raw material particles may be formed into a paste form and subjected to screen printing, or a doctor blade method may be used.

In some embodiments, in the laminating process, an alkali hydroxide in an equimolecular amount or larger with respect to hydrogen contained in the entire laminate may be added to the second layer. The alkali hydroxide is thought to diffuse also in the first layer in the firing process. In some embodiments, in the laminating process, raw materials having a molar ratio Ma/Mh (which is a ratio of the number of moles Ma of the alkali hydroxide to the number of moles Mh of H of the hydrogen-containing solid electrolyte) of 1 or more may be mixed to form a second layer. In some embodiments, the molar ratio Ma/Mh is 1 or more because decomposition of the solid electrolyte in the firing process and the like can be further reduced. In some embodiments, in consideration of the remaining alkali hydroxide, the molar ratio Ma/Mh is larger than 1. In some embodiments, in consideration of the remaining alkali hydroxide, the molar ratio Ma/Mh is 2.5 or less. In some embodiments, in this process, regarding the second layer, a second layer may be formed in which the alkali hydroxide remaining after firing is in a range of 36 volume % or less with respect to a solid electrolyte dehydrated from the hydrogen-containing solid electrolyte. In this range, since contact between solid electrolyte particles can be secured, decrease in the ion conductivity can be further reduced. In some embodiments, the amount of the remaining alkali hydroxide is in a range in which it remains at the grain boundary triple point.

In the laminating process, a first layer having a thickness in a range of 2 μm or more and 300 μm or less may be formed and a second layer having a thickness in a range of 2 μm or more and 100 μm or less may be formed. The thicknesses of the compact layer and the porous layer can be appropriately set within the range described in the composite structure.

In the laminating process, in the first layer and/or the second layer, a sintering aid other than the alkali hydroxide may be added. Examples of such a sintering aid include lithium borate. In this case, in some embodiments, the second layer that forms a porous layer contains an alkali hydroxide and a sintering aid other than the alkali hydroxide, and the first layer that forms a compact layer does not contain a sintering aid (such as an alkali hydroxide and lithium borate). In the first layer with less sintering aid, the generation of voids formed when a sintering aid melts and moves to the grain boundary can be reduced, and the second layer can be made a more compact layer. The sintering aid required for the first layer may be added to the second layer. It is thought that components of the sintering aid diffuse from the second layer to the first layer due to heating in the firing process. In addition, since there is a large amount of a sintering aid that generates voids in the second layer, it is possible to obtain a porous layer with more pores. In some embodiments, the sintering aid other than the alkali hydroxide is added in a range of 20 volume % or less (the content of the solid electrolyte is 80 volume % or more) with respect to the volume of the hydrogen-containing solid electrolyte. In some embodiments, the content of the sintering aid is 20 volume % or less because contact between solid electrolyte particles can be secured, and decrease in the ion conductivity can be further reduced. In some embodiments, an amount of the sintering aid added is 1 volume % or more, 2 volume % or more, or 5 volume % or more. In some embodiments, the amount of the sintering aid added is 15 volume % or less, 10 volume % or less, or 8 volume % or less.

In the firing process, the laminate is fired at a temperature at which a hydrogen-containing solid electrolyte and an alkali hydroxide are chemically sintered. In this process, hydrogen and hydroxide contained in the solid electrolyte chemically react to form water, water evaporates, and thus voids are generated, and formation of the porous layer is promoted. When no alkali hydroxide is added to the first layer, the alkali hydroxide present in the second layer diffuses during firing, and thus sintering occurs in the first layer without generation of voids, and the compact layer is formed. In some embodiments, the firing temperature is 1,100° C. or lower, 1,050° C. or lower, or 1,000° C. or lower. In firing at 1,100° C. or lower, firing energy can be further reduced. In some embodiments, in order to secure sinterability, the laminate is fired at 700° C. or higher, 750° C. or higher, or 800° C. or higher. The firing treatment can be performed in the air, and may be performed, for example, in an inert atmosphere such as nitrogen or an inert gas. The firing time may be appropriately set depending on the size and composition of the laminate, and may be, for example, 2 hours or longer, 5 hours or longer, or 8 hours or longer. In some embodiments, in consideration of energy consumption, the firing time is as short as possible, and may be 24 hours or shorter, 12 hours or shorter, or 10 hours or shorter.

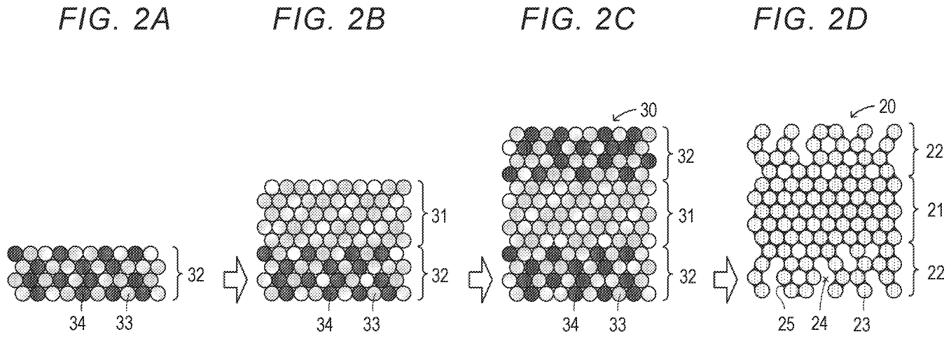

FIGS. 2A to 2D are explanatory diagrams of a method of producing a composite structure, FIG. 2A shows a second layer forming process, FIG. 2B shows a first layer forming process, FIG. 2C shows an additional second layer forming process, and FIG. 2D shows the composite structure after firing. First, initially, a second layer 32 serving as the porous layer 22 is formed using a mixed powder in which hydrogen-containing solid electrolyte particles 33 and sintering aid particles 34 are mixed at a predetermined mixing ratio (FIG. 2A). An alkali hydroxide is contained in the sintering aid particles 34. In addition, lithium borate may be contained in the sintering aid particles 34. Next, using the hydrogen-containing solid electrolyte particles 33 containing no sintering aid particles 34, a first layer 31 serving as a compact layer is formed on the second layer 32 (FIG. 2B). Then, the second layer 32 serving as the porous layer 22 is formed on the first layer 31 using the mixed powder to obtain a laminate 30 (FIG. 2C). Then, the hydrogen-containing solid electrolyte particles 33 and the sintering aid particles 34 (alkali hydroxide) chemically react and the composite structure in which the solid electrolyte particles 23 are sintered at the grain boundary part 25 containing a sintering aid can be obtained. The composite structure has a structure in which the porous layer 22 in which voids 24 are formed by evaporating the component of the sintering aid and the compact layer 21 in which no voids 24 are formed are integrally formed. The above composite structure can be produced through such a process.

In the composite structure, the lithium battery, and the method of producing a composite structure described above in detail, it is possible to prevent internal short circuiting of the secondary battery. The reason why such an effect is obtained is speculated as follows. For example, in this composite, it is speculated that a precipitation field in which a metal precipitates is secured in the porous layer, and a compact layer for preventing short circuiting is integrally formed, and thus both ion conductivity and short circuiting prevention can be achieved.

Here, it should be noted that the present disclosure is not limited to the above embodiment, and can be implemented in various forms within the technical scope of the present disclosure.

Hereinafter, examples in which the composite structure of the present disclosure is specifically produced will be described as experimental examples.

### [Production of Garnet Oxide]

First, Li_{6.8}(La_{2.95}Ca_{0.05})(Zr_{1.75}Nb_{0.25})O₁₂(LLZ-CN) containing no hydrogen was synthesized as solid electrolyte particles. LiOH(H₂O), La(OH)₃, Ca(OH)₂, ZrO₂, and Nb₂O₅ were used as starting raw materials. The starting raw materials were weighed out so that a stoichiometric ratio was obtained, and mixed and pulverized. Mixing and pulverization were performed in a planetary ball mill (300 rpm) in ethanol using zirconia balls for 1 hour. Then, preliminary firing (700° C., 48 h) was performed. After preliminary firing was performed, in order to compensate for Li deficiency during sintering, an excess amount of LiOH(H₂O) was added to the powder so that there was 10 at % with respect to Li in the composition. Then, mixing and pulverization were performed again under the same conditions. Then, preliminary firing (700° C., 10 h) was performed again. In the powder that had undergone the above preliminary firing twice, a crystal phase was identified by XRD, and it was confirmed that there were no remaining unreacted raw materials. Then, the LLZ-CN powder was immersed in water and thus Li and H were exchanged. Regarding immersion conditions, water and LLZ-CN were left at a ratio of 50 mg of water to 4 g of LLZ-CN, at room temperature (about 25° C.) for 30 minutes, and thus Li and H were exchanged. When the composition after exchange between Li and H in the condition was analyzed, it was (Li_{5.6}, H_{1.2})(La_{2.95}, Ca_{0.05})(Zr_{1.75}, Nb_{0.25})O₁₂ (LLZ-HCN). Here, an amount of H was identified as follows. First, the powder after H substitution was subjected to TG DTA-MASS measurement, a temperature range in which H₂O (molecular weight of 18) evaporated from a sample was determined in the MASS measurement, and a weight reduction amount in the temperature range was quantified as Tg. The atomic weight of H contained in LLZ-HCN was calculated from the mass and molecular weight of LLZ-CN, and the mass and molecular weight of evaporated water.

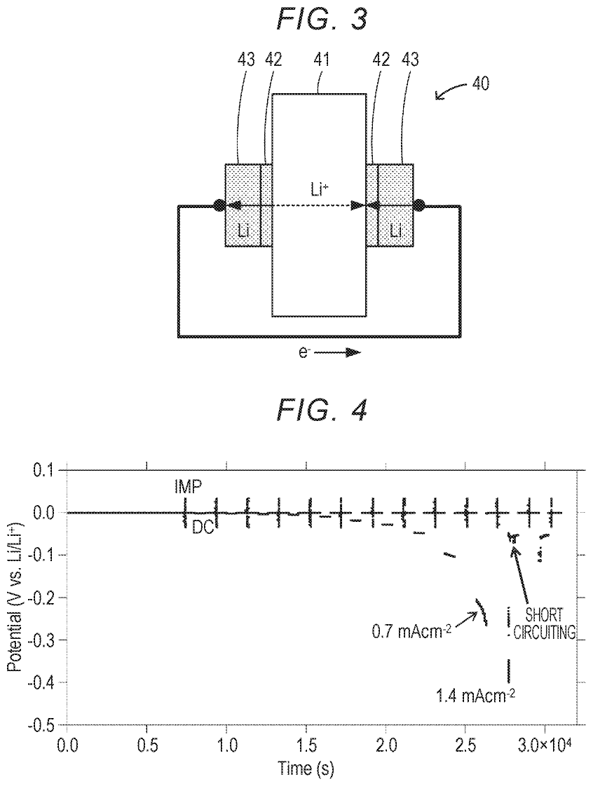

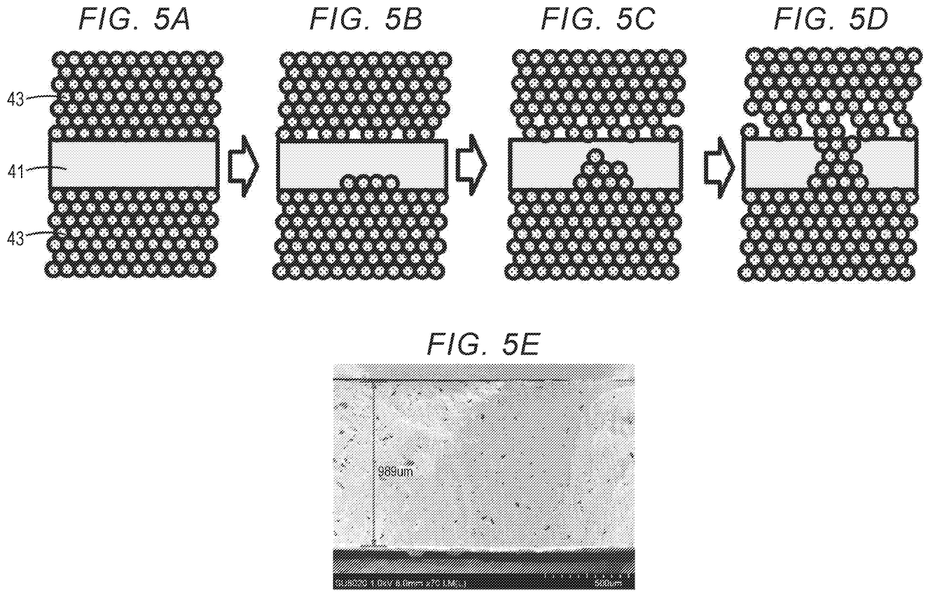

First, the solid electrolyte particles (LLZ-CN) were sintered to produce a separator, a symmetric cell having the same electrodes was produced, and short circuiting thereof was examined. FIG. 3 is an explanatory diagram of a symmetric cell 40 used for a Li dissolution precipitation test. The symmetric cell 40 included a separator 41, deposition layers 42 formed on a first surface and a second surface of the separator 41, and Li electrodes 43 pressed on the deposition layer 42. The separator 41 was a sintered product obtained by melting and sintering LLZ-CN with LBO. The symmetric cell 40 was produced by forming the deposition layer 42 in which the metal Li was vapor-deposited on a first surface and a second surface of the separator 41, and compressing a Li metal foil as a Li electrode thereon. The separator was produced by weighing out 89 volume % of LLZ-CN, 10 volume % of LBO as a sintering aid, and 1 volume % of Al₂O₃, performing press molding to a diameter of 11.28 mm, and a thickness of about 1.2 mm, and then performing sintering at 800° C. in the air. A dissolution precipitation test was performed using the symmetric cell 40. FIG. 4 is a diagram showing results of a dissolution precipitation test in which a current per unit area continuously increased with respect to a symmetric cell. In the dissolution precipitation test, a VMP3 galvanostat (commercially available from Biologic) was connected to Li electrodes, and a change in the potential when a current per unit area continuously increased was measured. As shown in FIG. 4, the potential increased to the negative side as the current increased. However, when it exceeded a certain current density, the Li-based potential was 0 V, and short circuiting of the electrode was confirmed. FIGS. 5A to 5D show metal precipitation model diagrams, and FIG. 5E shows a scanning electron microscope (SEM) image of a separator made of a solid electrolyte. SEM observation was performed using S-3600N (commercially available from Hitachi High-Technologies Corporation) under conditions of a magnification of 2,000 to 5,000. As shown in FIGS. 5A to 5D, when a current was applied to the symmetric cell, the metal Li was precipitated in voids inside the separator. It was speculated that the precipitated metal Li grew through voids and Li electrodes were short-circuited. That is, in the melting and sintering in which particles were fixed by melting the sintering aid, as shown in FIG. 5D, it was speculated that, since there were voids in the entire interior of the separator, the metal Li grew and short circuiting occurred.

Here, a method of preventing this short circuiting was examined. Inside the separator produced by mixing solid electrolyte particles and a sintering aid with a uniform composition, the sintering aid dispersed at the grain boundaries and thus voids were generated. It was difficult to eliminate the voids. On the other hand, in order to prevent internal short circuiting of the electrode, the presence of a compact layer having no voids was necessary. Therefore, it was assumed that generation of voids in the separator made of an inorganic solid electrolyte was allowed, the voids were segregated on the side of the first surface and on the side of the second surface opposite to the first surface, and a compact layer was formed at the central part. In addition, it was assumed that, in consideration of voids that function as a buffer in which the precipitated metal Li was stored, more voids were generated on the side of the first surface and the second surface. In addition, for example, according to the sintering aid that evaporated, it was expected that a porous layer having more voids was able to be formed on the side of the first surface and the second surface.

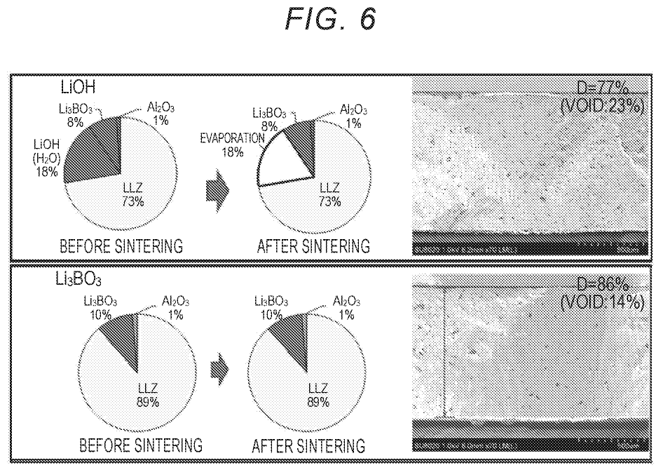

Next, the porosity of the separator was examined. In addition to using LBO and Al₂O₃ as a sintering aid, a sintering aid for obtaining pores was examined. Here, lithium hydroxide was examined as a sintering aid. FIG. 6 shows diagrams of the relationship between the composition and the porosity of the sintering aid. The relative density was calculated as a relative density when the density when the solid electrolyte had no voids was set as 100%. This relative density was calculated without considering a sintering aid. A sample obtained by adding 10 volume % of LBO and 1 volume % of Al₂O₃ to LLZ-CN was sintered at 800° C. for 24 h, and the obtained sintered product was used as Experimental Example 1. In addition, a sample obtained by adding 8 volume % of LBO and 18 volume % of LiOH to LLZ-HCN was sintered at 800° C. for 24 h, and the obtained sintered product was used as Experimental Example 2. Here, raw materials were selected assuming that the reaction of the following Formula (1) occurred. As shown in the lower part in FIG. 6, it was confirmed that the sintered product of Experimental Example 1 had 14 volume % of voids (relative density of 86%). This was speculated that, when the contained LBO particles moved to the grain boundary, voids were generated at positions at which there were LBO particles. In addition, as shown in the upper part in FIG. 6, it was confirmed that the sintered product of Experimental Example 2 had 23 volume % of voids (relative density of 77%). In this manner, it was found that, when LiOH and LLZ-HCN were used, H₂O produced by the reaction of LiOH and hydrogen evaporated, and it was possible to increase voids.

(Li_{5.4}H_{1.5})(La_{2.95}Ca_{0.05})(Zr_{1.4}Nb_{0.6})O₁₂+LiOH→(Li_{6.8})(La_{2.95}Ca_{0.05})(Zr_{1.4}Nb_{0.6})O₁₂+H₂O↑ Formula (1)

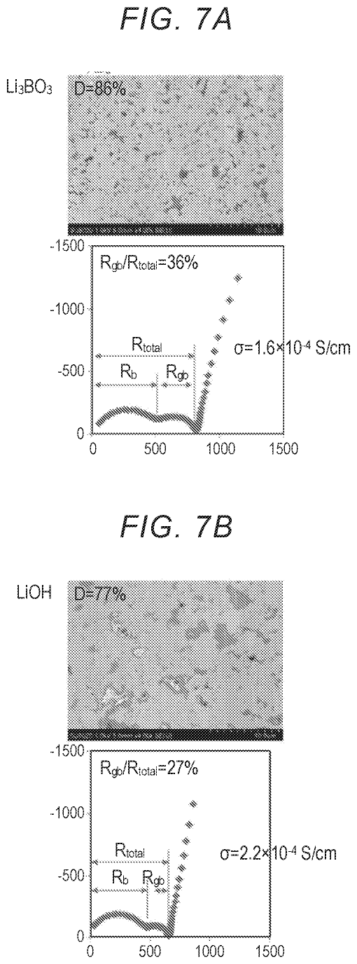

In addition, the electrical conductivity (ion conductivity) of Experimental Examples 1 and 2 was measured. The electrical conductivity was measured under the following conditions. In a thermostatic chamber, a resistance value was determined from the arc of the Nyquist plot using an AC impedance analyzer (Agilent 4294A) under conditions of a frequency of 40 Hz to 110 MHz and an amplitude voltage of 100 mV, and an electrical conductivity was calculated from the resistance value. An Au electrode was used as a blocking electrode during measurement using an AC impedance analyzer. The Au electrode was formed by baking a commercially available Au paste on the surface of the sintered product under conditions of 800° C. and 30 minutes. FIGS. 7A and 7B are diagrams of the relationship between the composition and the porosity of the sintering aid, and the electrical conductivity. FIG. 7A shows Experimental Example 1, and FIG. 7B shows Experimental Example 2. As shown in FIG. 7B, it was found that, in Experimental Example 2 in which LiOH was used as a sintering aid, the electrical conductivity at 25° C. was 2.2×10⁻⁴ S/cm, which was a value of 1.4 times 1.6×10⁻⁴ S/cm in Experimental Example 1, and the electrical conductivity was improved. Particularly, in Experimental Example 2, the grain-boundary resistivity Rgb was 27%, which was significantly reduced compared with 36% in Experimental Example 1, which suggested that binding between solid electrolyte particles was promoted.

Here, a hydrogen content of LLZ-HCN was examined. In a garnet oxide represented by a basic composition (Li_{7-3x+y-z-a}HₐMₓ)(La_{3-y}A_{y})(Zr_{2-z}T_{z})O₁₂, x=0, A=Ca, T=Nb, y=0.05, and z=0.6 were set, the hydrogen content a was changed in a range of 0.5≤a≤2.5, and a garnet oxide (solid electrolyte) sintered product was produced. Regarding sintered product production conditions, using raw materials to which the equimolal amount of LiOH as the amount of H was added as a sintering aid, a firing treatment was performed in the air at 800° C. for 24 hours. The electrical conductivity (ion conductivity) of the produced sintered product was measured under the same conditions as above. In the measurement results, when the hydrogen content a was in a range of 0.9≤a≤2.2, the electrical conductivity at 25° C. was high. In the measurement results, the value of the electrical conductivity was lower outside the above range. It was speculated that, when the hydrogen content a was less than 0.9, the electrical conductivity decreased because a chemical reaction for promoting sintering was weak. In addition, it was speculated that, when the hydrogen content a was larger than 2.2, the electrical conductivity decreased because the crystallinity of LLZ largely decreased based on XRD measurement results.

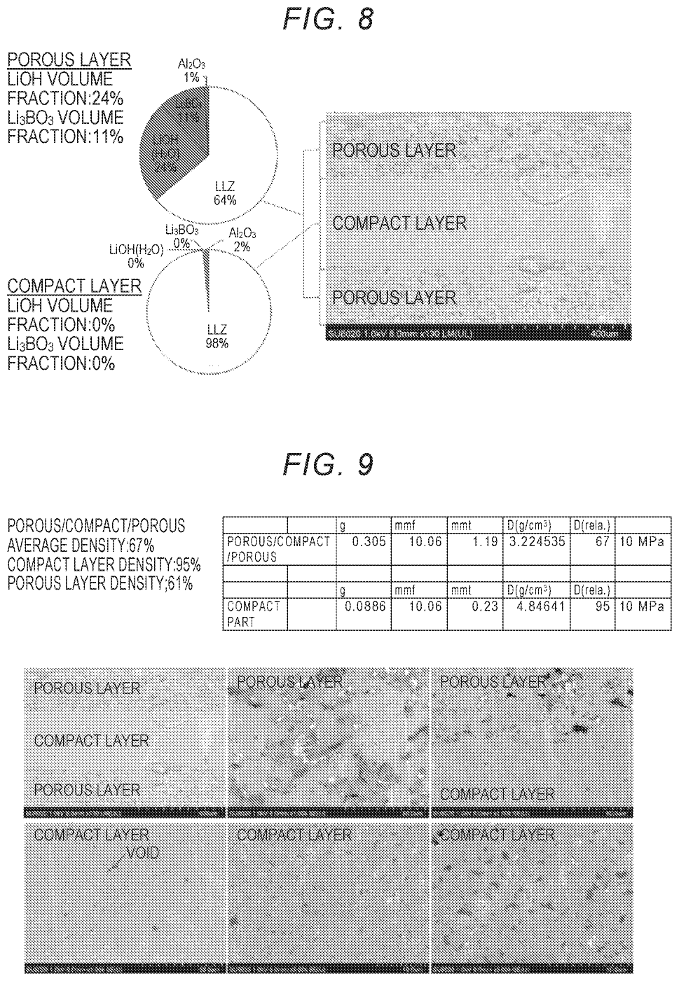

Next, the production of a composite structure of porous layer/compact layer/porous layer was examined. The composite structure was produced by gradually mixing LiOH as a sintering aid. First, 64 volume % of LLZHCN particles, 11 volume % of LBO as a sintering aid, 24 volume % of LiOH, and 1 volume % of Al₂O₃ particles as an additive were weighed out and mixed to form a layer form (second layer). The thickness of the second layer was 400 μm. Next, 98 volume % of LLZ-HCN particles, and 2 volume % of Al₂O₃ particles as an additive were weighed out and mixed to form a layer form (first layer) on the second layer. The thickness of the first layer was 400 μm. The second layer was additionally formed on the first layer to form a laminate (Experimental Example 3). The laminate was fired in the air at 800° C. at which chemical sintering occurred for 24 hours. During firing, LiOH and LBO present in the second layer diffused to the side of the first layer, and sintering was promoted. FIG. 8 shows a raw material volume fraction of the composite structure of porous layer/compact layer/porous layer and an SEM image after sintering. As shown in the SEM image in FIG. 8, it was possible to produce the composite structure of porous layer/compact layer/porous layer. Next, the porous layer of the obtained composite structure was cut out, and the density was determined from the volume and the mass. In addition, the compact layer was cut out, and the density was determined from the volume and the mass. Then, the true density of LLZ-CN was set as 100%, and the relative density of the porous layer and the compact layer was determined. FIG. 9 shows details of the SEM image of the composite structure of porous layer/compact layer/porous layer. As shown in FIG. 9, in the composite structure of Experimental Example 3, the average relative density was 67%, the relative density of the porous layer was 61%, and the relative density of the compact layer was 95%. In addition, the electrical conductivity of Experimental Example 3 at 25° C. was 2.4×10⁻⁴ S/cm.

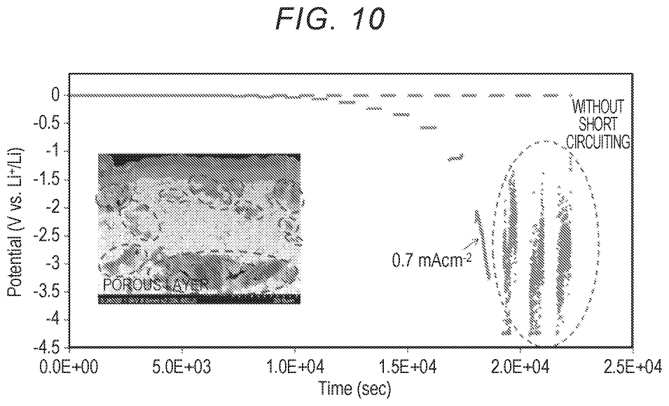

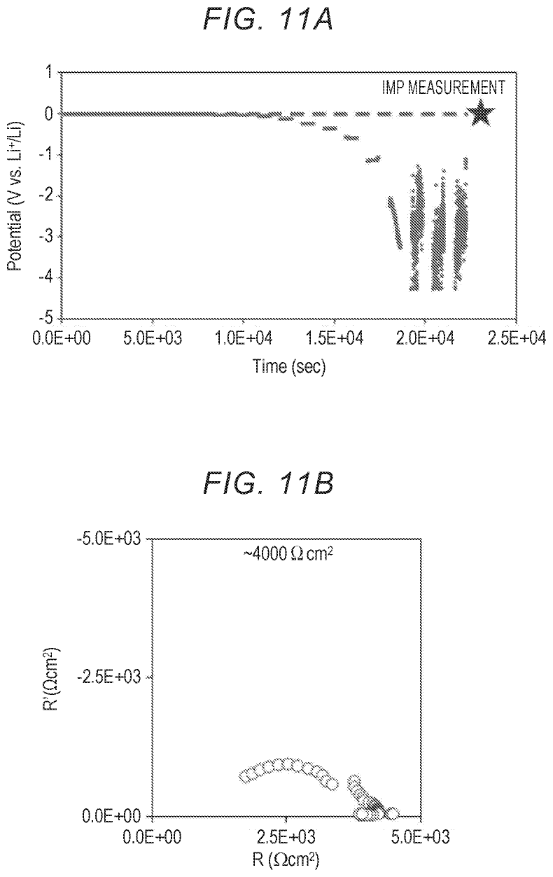

Next, a symmetric cell was produced using the composite structure of Experimental Example 3, and a Li dissolution precipitation test was performed. FIG. 10 shows results of a dissolution precipitation test for the composite structure of porous layer/compact layer/porous layer. As shown in FIG. 10, no internal short circuiting was confirmed. In addition, when a current per unit area exceeded 0.7 mA/cm², a trend of increasing resistance was confirmed. As shown in the SEM image of the cross section of the composite structure after the test, this was speculated that the metal Li was precipitated in voids of the porous layer. That is, it was speculated that the porous layer absorbed the precipitated metal Li and structural destruction of the composite structure or the like could be reduced. In addition, the impedance of the composite structure subjected to the Li dissolution precipitation test was measured. FIGS. 11A and 11B show results of impedance measurement of the composite structure subjected to the Li dissolution precipitation test. As shown in FIGS. 11A and 11B, a large resistance assumed to be caused by Li dissolution was confirmed, but short circuiting was not confirmed. In this manner, it was found that, in the composite structure of porous layer/compact layer/porous layer, when a precipitation field in which a metal was precipitated was secured in the porous layer and the compact layer for preventing short circuiting was integrally formed with the porous layer, it was possible to achieve both ion conductivity and short circuiting prevention.

Here, the composite structure, the lithium battery and the method of producing a composite structure of the present disclosure are not limited to the above examples, and can be implemented in various forms within the technical scope of the present disclosure.

The present disclosure can be used in the technical field of the battery industry.

What is claimed is:

1. A method of producing a composite structure adapted to a separator of a secondary battery, comprising:
a laminating process in which a first layer in which a hydrogen-containing solid electrolyte powder is filled and a second layer in which a powder obtained by mixing hydrogen-containing solid electrolyte particles and an alkali hydroxide is filled are formed to obtain a laminate; and
a firing process in which the laminate is fired at a temperature at which the hydrogen-containing solid electrolyte and the alkali hydroxide are chemically sintered.

2. The method of producing a composite structure according to claim 1,
wherein, in the laminating process, the first layer is formed using the hydrogen-containing solid electrolyte that is a garnet oxide containing at least Li, H, La and Zr, and the second layer is formed using the hydrogen-containing solid electrolyte that is a garnet oxide containing at least Li, H, La and Zr and the alkali hydroxide that is lithium hydroxide.

3. The method of producing a composite structure according to claim 2,
wherein, in the laminating process, the hydrogen-containing solid electrolyte represented by a basic composition (Li_{7-3x+y-z-a}HₐMₓ)(La_{3-y}A_{y})(Zr_{2-z}T_{z})O₁₂ is used,
and M is one or more of Al and Ga, A is one or more of Ca and Sr, T is one or more of Nb and Ta, and 0≤x≤0.2, 0≤y≤0.2, 0≤z≤2, and 0.9≤a≤2.2 are satisfied.

4. The method of producing a composite structure according to claim 1,
wherein, in the laminating process, a molar ratio Ma/Mh which is a ratio of the number of moles Ma of the alkali hydroxide to the number of moles Mh of H of the hydrogen-containing solid electrolyte is 1 or more, and the second layer in which the alkali hydroxide remaining after firing is in a range of 36 volume % or less with respect to a solid electrolyte dehydrated from the hydrogen-containing solid electrolyte is formed.

5. The method of producing a composite structure according to claim 1,
wherein, in the laminating process, the first layer having a thickness in a range of 2 μm or more and 300 μm or less is formed, and the second layer having a thickness in a range of 2 μm or more and 100 μm or less is formed.

6. The method of producing a composite structure according to claim 1,
wherein, in the laminating process, in at least one of the first layer and the second layer, 20 volume % or less of lithium borate with respect to a volume of the hydrogen-containing solid electrolyte is used.
